(19) United States
(12) Patent Application Publication
(10) Pub. No.: US 2022/0344646 A1
(43) Pub. Date: Oct. 27, 2022

(54) ELECTROCHEMICAL DEVICE AND ELECTRONIC DEVICE CONTAINING THE SAME

(71) Applicant: NINGDE AMPEREX TECHNOLOGY LIMITED, Ningde City (CN)

(72) Inventor: Tianjun LI, Ningde (CN)

(21) Appl. No.: 17/858,850

(22) Filed: Jul. 6, 2022

Related U.S. Application Data
(63) Continuation of application No. PCT/CN2020/070750, filed on Jan. 7, 2020.

(51) Int. Cl. H01M 4/36; H01M 10/0525; H01M 4/04

(52) U.S. Cl. CPC H01M 4/366; H01M 10/0525; H01M 4/0404; H01M 2004/027

(57) ABSTRACT

An electrochemical device includes: a positive electrode; a separator; and a negative electrode. The negative electrode includes a negative electrode current collector and a negative electrode active material layer. The negative electrode active material layer includes a negative electrode active material. The negative electrode active material layer includes a first negative electrode active material layer. When the electrochemical device is at a fully discharged state (0% SOC), the first negative electrode active material layer includes a first region and at least one second region. The first region is continuous as a whole, and at least a part of the second region is surrounded by the first region.

### CROSS-REFERENCE TO RELATED APPLICATION

This application is a continuation application of International Patent Application No. PCT/CN2020/070750, entitled “ELECTROCHEMICAL DEVICE AND ELECTRONIC DEVICE COMPRISING ELECTROCHEMICAL DEVICE” filed on Jan. 7, 2020, which is incorporated by reference in its entirety.

### TECHNICAL FIELD

This application relates to the technical field of energy storage, and in particular, to an electrochemical device and an electronic device containing the electrochemical device.

### BACKGROUND

With rapid development of mobile electronic technologies, people are using a mobile electronic device such as a smartphone, a tablet computer, a notebook computer, an unmanned aerial vehicle, and various wearable devices more often and people's experience requirements are increasingly higher. Therefore, an electrochemical device (such as a lithium-ion battery) that provides energy for the electronic device needs to provide a higher energy density, a higher C-rate, and higher safety.

The life and efficacy of a lithium-ion battery are closely related to stability of its negative electrode. In view of this, people keep researching negative electrode active materials of a higher energy density. However, materials of a higher energy density (such as a silicon-based material) are generally not compatible with existing cell structures, for example, due to a too low electrical conductivity, an excessive cycle expansion rate, and insufficient processing performance. Therefore, currently it is an urgent research topic to improve and optimize a cell structure (for example, a negative electrode, a separator, and a positive electrode) of the electrochemical device that uses a material of a high energy density as a negative electrode active material.

### SUMMARY

However, methods according to the prior art do not fully fulfill features required by an electrochemical device, and people are seeking solutions to alleviate, during cycles, expansion and deformation of a negative electrode made of a material of a high energy density.

This application provides an electrochemical device and an electronic device that contains the electrochemical device in an attempt to solve the foregoing problem to at least some extent.

As found through in-depth research by the inventor of this application among others, in a negative electrode with a negative electrode current collector coated with a negative electrode active material layer, the expansion and deformation of the negative electrode during cycles can be alleviated by designing a coating structure of the negative electrode active material layer in a fully discharged state (0% SOC).

Specifically, in order to solve the technical problem above, the following solutions are provided.

According to an aspect of this application, an electrochemical device is provided, including: a positive electrode; a separator; and a negative electrode. The negative electrode includes a negative electrode current collector and a negative electrode active material layer. The negative electrode active material layer includes a negative electrode active material. The negative electrode active material layer includes a first negative electrode active material layer. When the electrochemical device is at a fully discharged state (0% SOC), the first negative electrode active material layer includes a first region and at least one second region. The first region is continuous as a whole, and at least a part of the second region is surrounded by the first region.

The foregoing settings can alleviate volume expansion and deformation of the negative electrode during cycles, so as to achieve high cycle performance and safety performance.

According to an aspect of this application, the negative electrode active material layer further includes a binder.

According to an aspect of this application, the first region is coated with the negative electrode active material and the binder, and the second region is not coated with the negative electrode active material or the binder.

According to another aspect of this application, the first region is not coated with the negative electrode active material or the binder, and the second region is coated with the negative electrode active material and the binder.

In the electrochemical device according to this application, by letting the negative electrode include a region that is not coated with the negative electrode active material or the binder, a space is reserved in a case of a fully discharged state (0% SOC) to allow for expansion of the negative electrode active material during cycles. To be specific, when the first region is coated with the negative electrode active material and the binder, the second region is not coated with the negative electrode active material or the binder, and the second region reserves a space in the case of the fully discharged state (0% SOC), where the space allows for expansion of the negative electrode active material during cycles. When the first region is not coated with the negative electrode active material or the binder, the second region is coated with the negative electrode active material and the binder, and the first region reserves a space in the case of a fully discharged state (0% SOC), where the space allows for expansion of the negative electrode active material during cycles. The foregoing settings can alleviate volume expansion and deformation of the negative electrode during cycles, so as to achieve high cycle performance and safety performance.

According to an aspect of this application, the negative electrode active material layer further includes a second negative electrode active material layer. The second negative electrode active material layer is disposed between the negative electrode current collector and the first negative electrode active material layer, or the first negative electrode active material layer is disposed between the negative electrode current collector and the second negative electrode active material layer. A thickness of the first negative electrode active material layer is greater than or equal to 3 times a thickness of the second negative electrode active material layer.

The first negative electrode active material layer is formed by coating the negative electrode current collector with a negative electrode slurry. When the first region is coated with the negative electrode active material and the binder, at some coating thicknesses, a second negative electrode active material layer may be disposed on a surface of the first negative electrode active material layer. At some of the coating thicknesses, the second negative electrode active material layer may partly overlay the second region in the first negative electrode active material layer. At other of the coating thicknesses, the second negative electrode active material layer may fully overlay the second region in the first negative electrode active material layer.

The first negative electrode active material layer is formed by coating the negative electrode current collector with a negative electrode slurry. When the first region is not coated with the negative electrode active material or the binder, at some coating thicknesses, a second negative electrode active material layer may be included between the first negative electrode active material layer and the negative electrode current collector. At some of the coating thicknesses, the second negative electrode active material layer includes a seepage region. The seepage region is a region formed by the first negative electrode active material layer near the ending of the negative electrode current collector.

When the negative electrode active material layer includes a second negative electrode active material layer, the second negative electrode active material layer at least partly overlays the region that is not coated with the negative electrode active material or the binder in the first negative electrode active material layer. In this way, the region that is not coated with the negative electrode active material or the binder in the first negative electrode active material layer is downsized, thereby reducing the space reserved for expansion of the negative electrode active material during cycles, and in turn, impairing the effect of alleviating the volume expansion and deformation of the negative electrode during cycles. A large number of experimental studies and verifications by the inventor of this application among others show that when the thickness of the first negative electrode active material layer is greater than or equal to 3 times the thickness of the second negative electrode active material layer, the volume expansion and deformation of the negative electrode during cycles are effectively alleviated, and relatively high cycle performance and safety performance are achieved.

According to an aspect of this application, the second regions are distributed in form of an array. The second regions distributed in the form of an array enable the negative electrode active material to fully utilize the reserved expansion space during cycles, thereby alleviating the volume expansion and deformation of the negative electrode during cycle more effectively.

According to an aspect of this application, a circularity of the second region falls within a range of 0.3 to 1.0. After a plurality of cycles, in the fully discharged state (0% SOC), the second region is circular to some extent. When the circularity is deficient, the structure of the negative electrode active material layer is not conducive to alleviating the cycle expansion and deformation of the negative electrode active material. This applicant among others finds that when the circularity of the second region falls within the range of 0.3 to 1.0, the cycle expansion and deformation of the negative electrode can be alleviated effectively.

According to an aspect of this application, a compacted density M g/cm³ of the negative electrode active material layer and a gram capacity G mAh/g of the negative electrode active material satisfy the following formula: 2500/(G+1800)≤M≤4500/(G+1800).

Based on a large number of experimental studies, this applicant, among others, finds that if the compacted density of the negative electrode active material layer is deficient, the reserved expansion space is excessive, thereby not only wasting space and reducing the energy density of the electrochemical device, but also putting the electrochemical device at risk of lithium plating and being adverse to improving safety performance. If the compacted density of the negative electrode active material layer is excessive, the reserved expansion space is insufficient, and the cycle expansion and deformation of the negative electrode are ineffectively alleviated, thereby being adverse to improving the cycle performance. As verified, when the compacted density of the negative electrode active material layer and the gram capacity of the negative electrode active material satisfy the above formula, the cycle performance, safety performance, and energy density of the electrochemical device can reach a desirable level concurrently.

According to an aspect of this application, an area A μm² of the second region, a gram capacity G mAh/g of the negative electrode active material, and a particle size D μm of the negative electrode active material satisfy the following formula:

$$\frac{{{D}^{2} ( G - 360 )}^{2}}{1 {0}^{9}} \leq A \leq \frac{{{D}^{2} ( G - 360 )}^{2}}{1 {0}^{6}} .$$

Based on a large number of experimental studies, the applicant hereof among others finds that when the first region is coated with the negative electrode active material and the binder, if the area of the second region is excessive, the reserved expansion space can hardly be fully utilized during cycles, thereby not only reducing the energy density, but also being at risk of lithium plating. If the area of the second region is insufficient, the second region is prone to be blocked by broken negative electrode active material particles during cycles, thereby being ineffective in alleviating the cycle expansion and deformation of the negative electrode. When the first region is not coated with the negative electrode active material or the binder, if the area of the second region is excessive, a cycle expansion stress of the negative electrode active material in the second region can hardly be released effectively, and the reserved space can hardly be fully utilized, thereby posing a risk of lithium plating. If the area of the second region is insufficient, a coating structure of the second region is prone to be disrupted, thereby making the negative electrode ineffective in alleviating cycle expansion and deformation. As verified, when the area of the second region, the gram capacity of the negative electrode active material, and the particle size of the negative electrode active material satisfy the above formula, the cycle performance, safety performance, and energy density of the electrochemical device can reach a desirable level concurrently.

According to an aspect of this application, the particle size of the negative electrode active material is approximately 0.2 μm to approximately 10.0 μm.

According to another aspect of this application, an electronic device is provided. The electronic device includes the electrochemical device.

Additional aspects and advantages of the embodiments of this application will be partly described or illustrated later herein or expounded through implementation of the embodiments of this application.

### BRIEF DESCRIPTION OF DRAWINGS

For ease of describing the embodiments of this application, the following outlines the drawings needed for describing the embodiments of this application or the prior art. Evidently, the drawings outlined below are merely a part of embodiments in this application. Without making any creative efforts, a person skilled in the art can still derive the drawings of other embodiments according to the structures illustrated in these drawings.

FIG. 1 is a schematic diagram of lithiation-induced expansion of graphite versus silicon;

FIG. 2 is a schematic structural top view of a negative electrode active material layer according to some embodiments of this application;

FIG. 3 is a schematic structural diagram of a negative electrode active material layer with through-holes according to some embodiments of this application;

FIG. 4A to FIG. 4D are schematic structural side views of a negative electrode active material layer with through-holes according to some embodiments of this application;

FIG. 5 is a schematic structural diagram of a negative electrode active material layer with coated units according to some embodiments of this application;

FIG. 6A to FIG. 6C are a schematic structural side views of a negative electrode active material layer with coated units according to some embodiments of this application; and

FIG. 7 is a schematic diagram of a watermark generated after applying a negative electrode active material layer according to some embodiments of this application.

### DETAILED DESCRIPTION OF EMBODIMENTS

Embodiments of this application will be described in detail below. Throughout the specification of this application, the same or similar components and the components having the same or similar functions are denoted by similar reference numerals. The embodiments described herein with reference to the drawings are illustrative and graphical in nature, and are intended to enable a basic understanding of this application. The embodiments of this application are not to be construed as a limitation on this application.

The terms “roughly,” “substantially,” “substantively”, and “approximately” used herein are intended to describe and represent small variations. When used with reference to an event or situation, the terms may denote an example in which the event or situation occurs exactly and an example in which the event or situation occurs very approximately. For example, when used together with a numerical value, such a term may represent a variation range falling within ±10% of the numerical value, such as ±5%, ±4%, ±3%, ±2%, ±1%, ±0.5%, ±0.1%, or ±0.05% of the numerical value. For example, if a difference between two numerical values falls within ±10% of an average of the numerical values (such as ±5%, ±4%, ±3%, ±2%, ±1%, ±0.5%, ±0.1%, or ±0.05% of the average), the two numerical values may be considered “substantially” the same.

In this specification, unless otherwise specified or defined, relative terms such as “central”, “longitudinal”, “lateral”, “front”, “rear”, “right”, “left”, “internal”, “external”, “lower”, “higher”, “horizontal”, “perpendicular”, “higher than”, “lower than”, “above”, “under”, “top”, “bottom”, and derivative terms thereof (such as “horizontally”, “downward”, “upward”) are intended to be construed as a direction described in the context or a direction illustrated in the drawings. Such relative terms are merely used for ease of description, but not intended to require a construction or operation in this application to be performed in a given direction.

In addition, a quantity, a ratio, or another numerical value herein is sometimes expressed in the format of a range. Understandably, the format of a range is for convenience and brevity, and needs to be flexibly understood to include not only the numerical values explicitly specified and defined in the range, but also all individual numerical values or sub-ranges covered in the range as if each individual numerical value and each sub-range were explicitly specified.

In the embodiments and claims, a list of items referred to by using the terms such as “at least one of”, “at least one thereof”, “at least one type of” or other similar terms may mean any combination of the listed items. For example, if items A and B are listed, the phrases “at least one of A and B” and “at least one of A or B” mean: A alone; B alone; or both A and B. In another example, if items A, B, and C are listed, the phrases “at least one of A, B, and C” and “at least one of A, B, or C” mean: A alone; B alone; C alone; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

The term “XY expansion” herein means volume expansion of a negative electrode active material layer in a horizontal direction of a negative electrode current collector.

The term “compacted density” herein represents a weight density of an active material layer on a current collector, and is defined as the weight per unit volume of the active material layer.

The term “particle size” herein represents Dᵥ₅₀ denoting particle characteristics of a sample as obtained by carrying out a laser particle size test, and Dᵥ₅₀ is a particle diameter of a sample material measured when the cumulative volume percentage of particles of the material reaches 50% in a volume-based particle size distribution by starting from small-diameter particles.

The term “array” herein is defined as an arrangement of regions that are independent of each other without touching each other, and arranged in a given sequence.

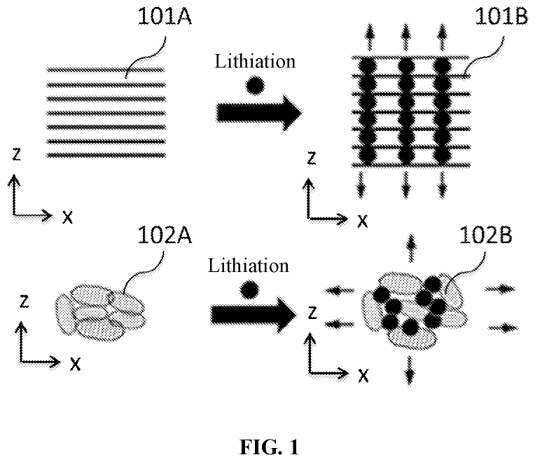

In the prior art, to pursue a higher energy density, attempts have been made to replace graphite in the conventional negative electrode active material with a negative electrode active material of a higher energy density. However, in applying such a negative electrode active material of a higher energy density, a large volume expansion during charge and discharge cycles causes deformation of a battery cell, and is prone to disrupt a structure of an electrochemical device and reduce a service life of the electrochemical device. Especially, for a lithium-ion battery, such an active material of a higher energy density incurs a huge volume effect (>300%) in lithiation and delithiation processes. Severe expansion of a negative electrode may cause deformation of an interface between the negative electrode and a separator or even cause detachment of the separator, thereby deteriorating cycle performance of the lithium-ion battery. For example, as shown in FIG. 1, in the prior art, a battery cell with a negative electrode of a high energy density incurs significant lateral expansion (such as XY expansion) in addition to expansion in a thickness direction (perpendicular to the drawing surface) during cycles. When graphite 101A is used as a negative electrode active material, due to a regular crystal structure, fully lithiated graphite 101B can be designed to expand vertically. In contrast, using a silicon-based material 102A as an example, when simple-substance silicon is fully lithiated as a negative electrode active material, the volume expansion rate of the fully lithiated silicon-based material 102B is approximately 320%. If a silicon particle is equivalent to a sphere, the XY expansion rate of the material is up to approximately 210%. The expansion of the negative electrode during cycles brings a huge lateral tensile force to the negative electrode current collector, separator, and the like. In severe cases, the expansion leads to detachment of the negative electrode active material layer from the negative electrode current collector in the battery cell and deformation of the negative electrode current collector, and in turn, results in battery failure during cycles.

With a view to alleviating the expansion of the negative electrode, this application reserves a space for cycle expansion in the negative electrode active material layer to suppress possible volume expansion and deformation of the negative electrode active material during charge and discharge cycles.

By designing parameters such as a ratio of the area of a recessed cell region to the area of a non-recessed region in a gravure cylinder, and a shape of the recessed cell in a gravure coating process, this application can achieve a negative electrode active material layer designed in a given coating structure. For example, when a specifically shaped non-recessed region is designed on the gravure cylinder, a through-hole region in a corresponding shape will be left in the negative electrode active material layer. When a specifically shaped recessed cell region is designed on the gravure cylinder, a coated region in a corresponding shape will be left in the negative electrode active material layer. On the basis of achieving a given weight density, the negative electrode active material layer reserves a space allowing for the expansion of the negative electrode active material. The negative electrode active material layer is applicable to a negative electrode containing a negative electrode active material of a high energy density, such as simple substances, alloys or compounds of silicon, tin, germanium, antimony, bismuth, or aluminum, thereby effectively alleviating expansion of the negative electrode and helping to alleviate deformation of the battery cell. In addition, due to the suppression of expansion and deformation, the interface between the negative electrode and the separator is of higher performance, thereby increasing the cycle capacity retention rate.

According to an aspect of this application, this application provides an electrochemical device, including: a positive electrode; a separator; and a negative electrode. The negative electrode includes a negative electrode current collector and a negative electrode active material layer. The negative electrode active material layer includes a negative electrode active material. The negative electrode active material layer includes a first negative electrode active material layer.

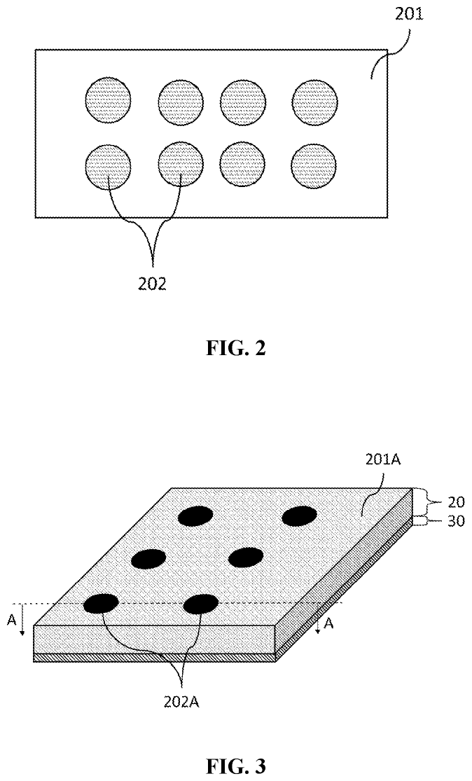

FIG. 2 is a schematic structural diagram of a negative electrode active material layer (first negative electrode active material layer) according to an embodiment of this application.

As shown in FIG. 2, when the electrochemical device is at a 0% state of charge (SOC), the first negative electrode active material layer includes a first region 201 and at least one second region 202. The first region 201 is continuous as a whole, and at least a part of the second region 202 is surrounded by the first region 201.

The term “state of charge” herein represents a state of available electrical energy in an electrochemical device, and is 100% when the electrochemical device is fully charged (in a fully charged state) and is 0% when the electrochemical device is fully discharged.

In some embodiments, the negative electrode active material layer includes a negative electrode material capable of absorbing and releasing lithium (Li) (hereinafter sometimes referred to as “negative electrode material capable of absorbing/releasing lithium Li”). Examples of the negative electrode material capable of absorbing/releasing lithium (Li) may include a carbon material, a metal compound, an oxide, a sulfide, a lithium nitride such as LiN₃, a lithium metal, a metal that combines with lithium into an alloy, and a polymer material. In some embodiments, among the materials capable of absorbing/releasing lithium (Li), examples of materials particularly made of active components of a high energy density include simple substances, alloys or compounds of silicon, tin, germanium, antimony, bismuth, or aluminum. For example, a theoretical specific capacity of silicon in an active component is up to 4200 mAh/g, which is more than ten times that of a conventional graphite negative electrode (a theoretical specific capacity of graphite is 372 mAh/g. In some embodiments, the active component is a silicon-based material. The silicon-based material may include simple-substance silicon, a silicon compound, a silicon alloy, or any combination thereof. Alternatively, the silicon-based material may include a silicon-oxygen material SiOₓ, where x is 0.5 to 1.5. The silicon-oxygen material includes a crystalline material, a non-crystalline material, or a combination thereof.

The foregoing settings can alleviate volume expansion and deformation of the negative electrode during cycles, so as to achieve high cycle performance and safety performance.

When the negative electrode active material of the negative electrode active material layer includes a silicon-based material, a compacted density of the negative electrode active material layer is related to a gram capacity of the negative electrode active material. In some embodiments, the compacted density M g/cm³ of the negative electrode active material layer and the gram capacity G mAh/g of the negative electrode active material satisfy the following formula:

2500/(G+1800)≤M≤4500/(G+1800).

In some embodiments, an area A μm² of the second region, the gram capacity G mAh/g of the negative electrode active material, and a particle size D μm of the negative electrode active material satisfy the following formula:

$$\frac{{{D}^{2} ( G - 360 )}^{2}}{1 {0}^{9}} \leq A \leq \frac{{{D}^{2} ( G - 360 )}^{2}}{1 {0}^{6}} .$$

By controlling the relationship between the compacted density M g/cm³ of the negative electrode active material layer and the gram capacity G mAh/g of the negative electrode active material, the electrochemical device according to this application can reserve a sufficient space against the expansion and deformation of the negative electrode active material on the basis of maintaining a given energy density. In addition, by controlling the relationship between the area A μm² of the second region, the gram capacity G mAh/g of the negative electrode active material, and the particle size D μm of the negative electrode active material, this application enhances the effect of alleviating the expansion and deformation of the negative electrode active material.

In some embodiments, the negative electrode active material layer further includes a binder.

In some embodiments, the particle size of the negative electrode active material layer is approximately 0.2 μm to approximately 10.0 μm.

In some embodiments, the gram capacity of the negative electrode active material layer is approximately 355 mAh/g to approximately 4200 mAh/g.

In some embodiments, the circularity of the second region falls within a range of 0.3 to 1.0.

In some embodiments, the first negative electrode active material layer further includes a binder and a conductive agent. The binder includes ingredients selected from polyacrylate, polyimide, polyamide, polyamide imide, polyvinylidene difluoride, styrene butadiene rubber, sodium alginate, polyvinyl alcohol, polytetrafluoroethylene, polyacrylonitrile, sodium carboxymethyl cellulose, potassium carboxymethyl cellulose, or any combination thereof. The conductive agent includes ingredients selected from conductive carbon black, acetylene black, Ketjen black, graphene, or any combination thereof.

Understandably, a person skilled in the art may choose to add any conventional binder or conductive agent according actual requirements without limitation.

FIG. 3 is a schematic structural diagram of a negative electrode active material layer with through-holes according to some embodiments of this application.

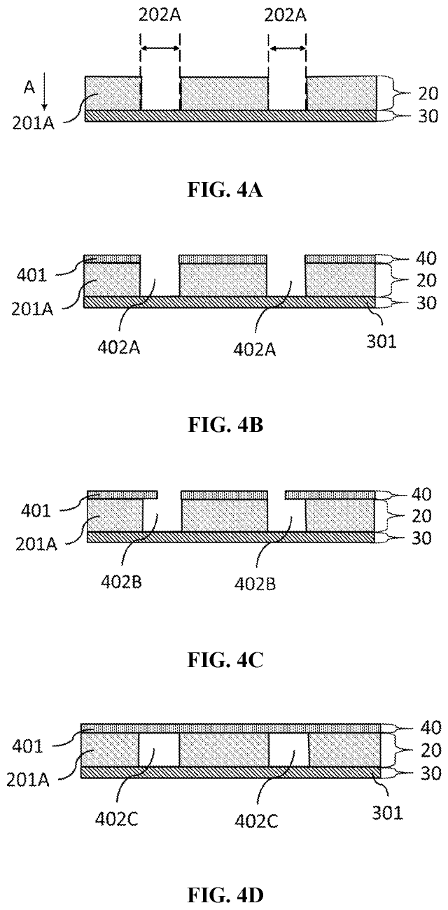

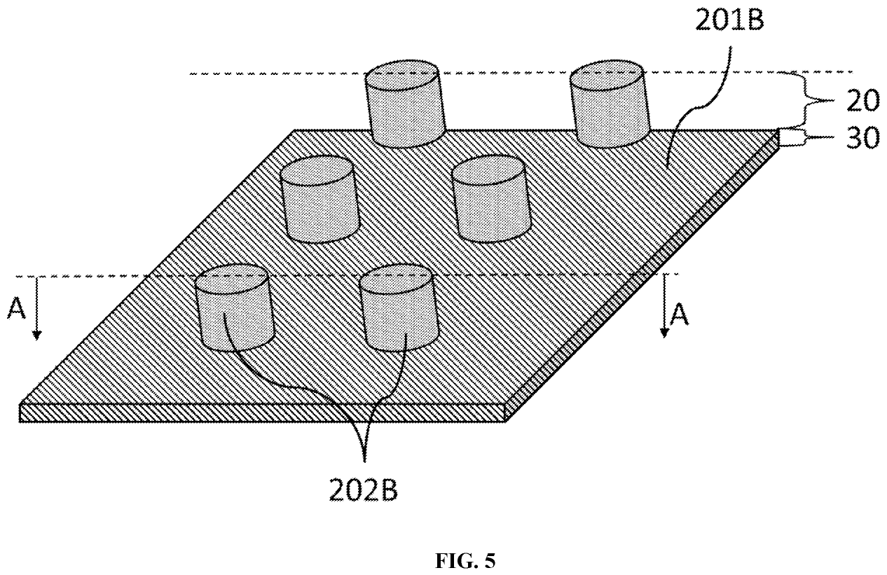

FIG. 4A to FIG. 4D are schematic structural side views of a negative electrode active material layer with through-holes according to some embodiments of this application.

As shown in FIG. 3 and FIG. 4A, in some embodiments, the first region is a coated region 201A formed on a negative electrode current collector 30 by using recessed cell regions on a gravure cylinder. The second region is a through-hole region 202A formed in the first negative electrode active material layer 20 by using specifically shaped non-recessed regions on the gravure cylinder. In some embodiments, the coated region 201A is coated with the negative electrode active material and the binder, and the through-hole region 202A is not coated with the negative electrode active material or the binder.

As shown in FIG. 4B to FIG. 4D, in some embodiments, the negative electrode active material layer further includes a second negative electrode active material layer 40. The second negative electrode active material layer 40 is a layer of negative electrode active material 401 formed on the first negative electrode active material layer 20 by the gravure cylinder at different coating thicknesses by using the specifically shaped non-recessed regions. Referring to FIG. 4B, when the coating thickness of the first negative electrode active material layer 20 is less than approximately 20 μm, the second negative electrode active material layer 40 can cause specifically shaped through-holes 402A to be left in the through-hole region 202A. Referring to FIG. 4C, when the coating thickness of the first negative electrode active material layer 20 is approximately 10 μm to approximately 40 μm, the second negative electrode active material layer 40 enables the through-hole region 202A to include a semi-closed hole 402B. The semi-closed hole is defined as a cavity which, with reference to the shape of a hole, is partly capped but still leaves an open part. Referring to FIG. 4D, when the coating thickness of the first negative electrode active material layer 20 is greater than approximately 20 μm, the second negative electrode active material layer 40 enables the through-hole region 202A to include a closed hole 402C. The closed hole is defined as a cavity which, with reference to the shape of a hole, is fully capped and leaves an internal hollow that is closed. The composition of the first negative electrode active material layer may be identical to or different from the composition of the second negative electrode active material layer. There is no clear boundary between the first negative electrode active material layer and the second negative electrode active material layer.

In some embodiments, when the coating thickness of the first negative electrode active material layer 20 is approximately 10 μm to approximately 20 μm, the second negative electrode active material layer 40 enables the through-hole region 202A to include both through-holes 402A and semi-closed holes 402B concurrently. In some embodiments, when the coating thickness of the first negative electrode active material layer 20 is approximately 20 μm to approximately 40 μm, the second negative electrode active material layer 40 enables the through-hole region 202A to include both semi-closed holes 402B and closed holes 402C concurrently.

In some embodiments, the thickness of the first negative electrode active material layer 20 is greater than or equal to 3 times the thickness of the second negative electrode active material layer 40.

FIG. 5 is a schematic structural diagram of a negative electrode active material layer with coated units according to some embodiments of this application;

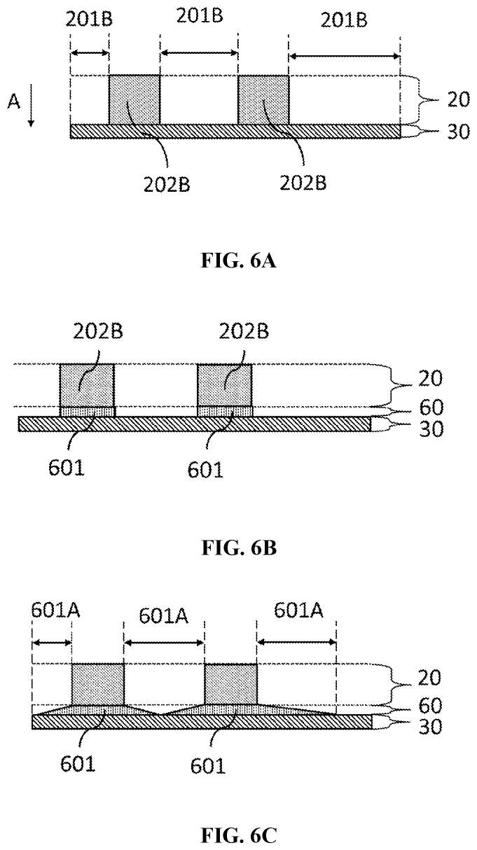

FIG. 6A to FIG. 6C are a schematic structural side views of a negative electrode active material layer with coated units according to some embodiments of this application.

As shown in FIG. 5 and FIG. 6A, in some embodiments, the first region is an uncoated region 201B formed on the negative electrode current collector 30 by using non-recessed regions on the gravure cylinder. The second region is a coated unit 202B formed on the negative electrode current collector 30 by using specifically shaped recessed cell regions on the gravure cylinder. In some embodiments, the coated unit 202B is coated with the negative electrode active material and the binder, and the uncoated region 201B is not coated with the negative electrode active material or the binder.

As shown in FIG. 6B and FIG. 6C, in some embodiments, the negative electrode active material layer further includes a second negative electrode active material layer 60. The second negative electrode active material layer 60 is a layer of negative electrode active material 601 formed between the first negative electrode active material layer 20 and the negative electrode current collector 30 by the gravure cylinder at different coating thicknesses by using the specifically shaped recessed cell regions. Referring to FIG. 6B, when the coating thickness of the first negative electrode active material layer 20 is less than approximately 20 μm, the coated unit 202B can form a clear and specifically shaped array on the surface of the negative electrode current collector 30. Referring to FIG. 6C, in some embodiments, when the coating thickness of the first negative electrode active material layer 202B is greater than approximately 5 μm, the second negative electrode active material layer 60 includes a seepage region 601A. The seepage region 601A is defined as a negative electrode active material layer 601 formed at an end close to the negative electrode current collector 30 in a coating process of the first negative electrode active material layer 20.

In some embodiments, the thickness of the first negative electrode active material layer 20 is greater than or equal to 3 times the thickness of the second negative electrode active material layer 60.

In some embodiments, the method for preparing a negative electrode in this application includes the following steps:

taking a given amount of negative electrode active material, mixing the material with a binder and a conductive agent at a fixed weight ratio, adding the mixture into deionized water, and stirring well; sifting the well stirred mixture to obtain a mixed slurry; and

coating a negative electrode current collector (such as a copper foil) with the mixed slurry by using a gravure cylinder that includes specially designed recessed cell regions or non-recessed regions, and drying; and performing cold pressing after completion of drying, so as to obtain a negative electrode active material layer.

Understandably, without departing from the spirit of this application, the steps in the method for preparing the negative electrode in the embodiments of this application may be selected according to specific requirements, or may replace other conventional processing methods in the art without limitation.

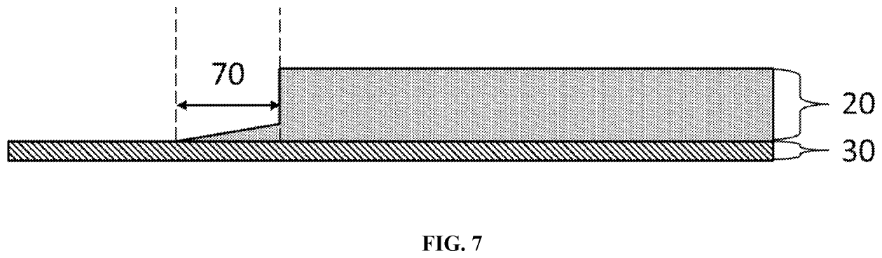

FIG. 7 is a schematic diagram of a watermark generated after applying a negative electrode active material layer according to some embodiments of this application.

As shown in FIG. 7, the term “watermark” herein is defined as a coated region 70 formed by extending a coating end face of the negative electrode active material layer toward the negative electrode current collector 30, and is less than or equal to approximately 3 μm in thickness.

In some embodiments, the coating method above can effectively reduce watermark phenomena of the negative electrode after the negative electrode active material layer is applied.

In some embodiments, the length of the watermark is related to silicon content in the negative electrode active material layer. The length of the watermark is less than or equal to (G+1200)/600 mm, where G is the gram capacity of the negative electrode active material. In some embodiments, the length of the watermark is less than approximately 3 mm.

In some embodiments, the electrochemical device is a lithium-ion battery.

In some embodiments, the positive electrode includes a positive current collector, and the negative electrode includes a negative electrode current collector. The positive current collector may be an aluminum foil or a nickel foil, and the negative electrode current collector may be a copper foil or a nickel foil. However, other positive current collectors and negative electrode current collectors commonly used in the art may also be used without limitation.

In some embodiments, the positive electrode includes a positive active material layer. The positive active material layer includes a positive active material capable of absorbing and releasing lithium (Li) (hereinafter sometimes referred to as “positive active material capable of absorbing/releasing lithium Li”). Examples of the positive active material capable of absorbing/releasing lithium (Li) may include one or more of lithium cobalt oxide, lithium nickel cobalt manganese oxide, lithium nickel cobalt aluminum oxide, lithium manganese oxide, lithium iron manganese phosphate, lithium vanadium phosphate, lithium vanadyl phosphate, lithium iron phosphate, lithium titanium oxide, and a lithium-rich manganese-based materials.

In the positive active material, the chemical formula of the lithium cobalt oxide may be Li_{y}CoₐM1_{b}O2_{-c}, where M1 is selected from at least one of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), and silicon (Si), and values of y, a, b, and c are in the following ranges: 0.8≤y≤1.2, 0.8≤a≤1, 0≤b≤0.2, −0.1≤c≤0.2, respectively.

In the positive active material, the chemical formula of the lithium nickel cobalt manganese oxide or the lithium nickel cobalt aluminum oxide may be Li_{z}Ni_{d}M2ₑO_{2-f}, where M2 is selected from at least one of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), zirconium (Zr), and silicon (Si), and values of z, d, e, and f are in the following ranges: 0.8≤z≤1.2, 0.3≤d≤0.98, 0.02≤e≤0.7, −0.1≤f≤0.2, respectively.

Among the positive active materials, the chemical formula of lithium manganese oxide is LiᵤMn_{2-g}M3_{g}O₄₋ₕ, where M3 is selected from at least one of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and values of z, g, and h are in the following ranges: 0.8≤u≤1.2, 0≤g≤1.0, and −0.2≤h≤0.2, respectively.

In some embodiments, the positive active material layer may further include at least one of a binder or a conductive agent. Understandably, a person skilled in the art may select a conventional binder and a conventional conductive agent according actual requirements without limitation.

In some embodiments, the separator includes, but is not limited to, at least one of polyethylene, polypropylene, polyethylene terephthalate, polyimide, and aramid. For example, the polyethylene includes a component selected from at least one of high-density polyethylene, low-density polyethylene, and ultra-high-molecular-weight polyethylene. Especially, the polyethylene and the polypropylene are highly effective in preventing short circuits, and improve stability of the battery through a turn-off effect.

The lithium-ion battery according to this application further includes an electrolyte. The electrolyte may be one or more of a gel electrolyte, a solid-state electrolyte, and an electrolytic solution. The electrolytic solution includes a lithium salt and a nonaqueous solvent.

In some embodiments, the lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt is LiPF₆ because it provides a high ionic conductivity and improves cycle characteristics.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, and any combination thereof.

In some embodiments, the nonaqueous solvent is selected from groups that each include ethylene carbonate, propylene carbonate, diethyl carbonate, dimethyl carbonate, ethyl methyl carbonate, propylene carbonate, methyl acetate, ethyl propionate, fluoroethylene carbonate, and any combination thereof.

Understandably, the methods for preparing the positive electrode, separator, electrolyte, and lithium-ion battery in embodiments of this application may be, but without limitation, any appropriate conventional methods in the art selected according to specific requirements without departing from the spirit of this application. In an implementation solution of the method for manufacturing an electrochemical device, the method for preparing a lithium-ion battery includes: winding, folding, or stacking the negative electrode, the separator, the positive electrode in the foregoing embodiments sequentially to form an electrode assembly; putting the electrode assembly into, for example, an aluminum plastic film, and injecting an electrolytic solution; and then performing steps such as vacuum packaging, static standing, formation, and shaping to obtain a lithium-ion battery.

Although the lithium-ion battery is used as an example for description above, a person skilled in the art after reading this application can learn that the negative electrode in this application is applicable to other suitable electrochemical devices. Such electrochemical devices include any device in which an electrochemical reaction occurs. Specific examples of the devices include all kinds of primary batteries, secondary batteries, fuel batteries, solar batteries, or capacitors. In particular, the electrochemical device is a lithium secondary battery, including a lithium metal secondary battery, a lithium-ion secondary battery, a lithium polymer secondary battery, or a lithium-ion polymer secondary battery.

Some embodiments of this application further provide an electronic device. The electronic device includes the electrochemical device in the embodiments of this application.

The electronic device according to the embodiments of this application is not particularly limited, and may be any electronic device known in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game console, a watch, a power tool, a flashlight, a camera, a large household battery, a lithium-ion capacitor, and the like.

### EMBODIMENTS

The following enumerates some specific embodiments and comparative embodiments, and performs a cycle performance test, a cycle thickness expansion rate test, a lithium plating test, a deformation test, and an after-cycling circularity test on the electrochemical device (lithium-ion battery) to describe the technical solutions of this application more clearly.

I. Test Methods

Testing the Cycle Performance:

Putting a lithium-ion battery in the following embodiments and comparative embodiments into a 25° C.±2° C. thermostat, leaving the battery to stand for 2 hours, charging the battery at a constant current of 0.5 C until the voltage reaches 4.4 V, charging the battery at a constant voltage of 4.4 V until the current reaches 0.02 C, and leaving the battery to stand for 15 minutes; discharging the battery at a constant current of 0.5 C until the voltage reaches 3.0 V, thereby completing one charge and discharge cycle; recording a first-cycle discharge capacity of the lithium-ion battery; and then performing charge and discharge cycles repeatedly according to the foregoing method, recording a discharge capacity at the end of each charge and discharge process, and comparing the discharge capacity with the first-cycle discharge capacity to obtain a cycle capacity curve.

Testing the batteries in groups, where each group includes 4 lithium-ion batteries, and calculating an average of cycle capacity retention rates of the lithium-ion batteries: cycle capacity retention rate of each lithium-ion battery=(100^{th}-cycle discharge capacity (mAh)/first-cycle discharge capacity (mAh)×100%.

Testing the Cycle Thickness Expansion Rate:

Using a 600 g parallel plate gauge (Elastocon, EV 01) to measure an average thickness of the lithium-ion batteries. Putting the lithium-ion batteries in the following embodiments and comparative embodiments into a 25° C.±2° C. thermostat, leaving the batteries to stand for 2 hours, charging the batteries at a constant current of 0.5 C until the voltage reaches 4.4 V, and then charging the batteries at a constant voltage of 4.4 V until the current reaches 0.02 C, and leaving the batteries to stand for 15 minutes; discharging the batteries at a constant current of 0.5 C until the voltage reaches 3.0 V, thereby completing one charge and discharge cycle; recording an average thickness of the lithium-ion batteries in a fully charged state after completion of the first cycle; and then performing 400 charge and discharge cycles repeatedly according to the foregoing method, and recording an average thickness of the lithium-ion batteries in the fully charged state after completion of each cycle.

Testing the batteries in groups, where each group includes 4 lithium-ion batteries, and calculating an average of the cycle thickness expansion rates of the lithium-ion batteries: cycle thickness expansion rate of a lithium-ion battery=(thickness of the lithium-ion battery after 400 cycles/thickness of a fresh lithium-ion battery−1)×100%.

Lithium Plating Test:

Putting the lithium-ion batteries in the following embodiments and comparative embodiments into a 25° C.±2° C. thermostat, leaving the batteries to stand for 2 hours, discharging the batteries at a constant current of 0.5 C until the voltage reaches 3.00 V, leaving the batteries to stand for 5 minutes, then charging the batteries at a constant current of 0.5 C until the voltage reaches 4.4 V, and then charging the batteries at a constant voltage of 4.4 V until the current reaches 0.02 C, thereby completing a lithium plating test cycle. After repeating the lithium plating test cycle for 10 times, discharging the lithium-ion batteries at a constant current of 0.5 C until the voltage reaches 3.00 V, and then disassembling each lithium-ion battery and calculating a ratio S of a lithium plating area (grayed) to the area of the negative electrode active material layer. The degree of lithium plating is determined based on the ratio S of the lithium plating area (grayed) of the negative electrode in the fully charged state to the area of the negative electrode active material layer: the ratio of less than 3% represents slight lithium plating, the ratio of 3% to 5% represents lithium plating, and the ratio of greater than 5% represents severe lithium plating.

Deformation Rate Test:

Sampling 3 points at the thickest part of the lithium ion batteries in the following embodiments and comparative embodiments, measuring the thickness at the points with a micrometer, and calculating an average. The average is referred to as a MMC (Maximum Material Condition) thickness. deformation rate of a lithium-ion battery=(MMC thickness−average thickness of the lithium-ion batteries)/MMC thickness.

Testing Circularity after Cycles:

Performing a cycle test on the lithium-ion batteries in the following embodiments and comparative embodiments until full discharge (0% SOC). Disassembling each lithium ion battery, taking out the negative electrode, and cutting the negative electrode to expose a cross section. Capturing an image of the through-hole (coated by a gravure cylinder that includes specifically shaped non-recessed regions) or the coated unit (coated by a gravure cylinder that includes specifically shaped recessed cell regions) at the cross section by using a scanning electron microscope (SEM). Selecting 20 through-holes or coated units randomly and calculating the average circularity thereof. The circularity is defined as:

$$circularity = \frac{S}{π {r}^{2}} ,$$

where S is the area of a figure, and r is a radius of a smallest circumcircle of the figure.

II. Preparation Methods

Preparing a Positive Electrode

Dissolving lithium cobalt oxide (LiCoO₂), conductive carbon black, and polyvinylidene difluoride (PVDF) in an N-methylpyrrolidone (NMP) solution at a weight ratio of 97.7:1.0:1.3 to form a positive slurry. Using an aluminum foil as a positive current collector, coating the positive electrode slurry onto the positive current collector, and performing steps of drying, cold pressing, and cutting to obtain a positive electrode.

Preparing an Electrolytic Solution

Mixing lithium hexafluorophosphate, fluoroethylene carbonate (FEC), and a nonaqueous organic solvent (at a weight ratio of ethylene carbonate (EC):dimethyl carbonate (DMC):diethyl carbonate (DEC)=1:1:1) in an environment with a moisture content of less than 10 ppm to formulate an electrolytic solution in which the weight percent of the FEC is 10 wt % and the concentration of the lithium hexafluorophosphate is 1 mol/L.

Preparing a Lithium-Ion Battery

Using a polyethylene (PE) porous polymer film as a separator; Sequentially stacking the positive electrode, the separator, and the negative electrode in the following embodiments and comparative embodiments, placing the separator between the positive electrode and the negative electrode to serve a function of separation, and then winding them into an electrode assembly. Subsequently, putting the electrode assembly into an aluminum plastic film packaging bag, and drying at 80° C. to obtain a dry electrode assembly. Subsequently, injecting the electrolytic solution into the dry electrode assembly, and performing steps such as vacuum packaging, standing, formation, and shaping to complete preparing the lithium-ion batteries disclosed in the following embodiments.

### Embodiment 1

Mixing a silicon-based material and graphite to form a negative electrode active material, where the particle size of the negative electrode active material is 10 μm, and the gram capacity of the negative electrode active material is 620 mAh/g. Adding the negative electrode active material, styrene-butadiene polymer, sodium carboxymethyl cellulose, and conductive carbon black into deionized water at a weight ratio of 94.4:1.6:1.0:3.0 to form a negative electrode slurry. Using a copper foil as a negative electrode current collector. Using a gravure cylinder that includes specifically shaped non-recessed regions, where the area of each non-recessed region (corresponding to the area of the second region after coating) is 20 μm². Coating the current collector with the negative electrode slurry, where the thickness of the coating is 10 μm. Subsequently, drying in an oven at a temperature of 90° C. to 120° C. to obtain a negative electrode active material layer with through-holes. The compacted density of the negative electrode active material layer is 1.3 g/cm³. Performing steps of drying, cold pressing, and cutting to obtain a negative electrode.

### Embodiment 2

The preparation method is the same as that in Embodiment 1 except: in Embodiment 2, the gravure cylinder that includes specifically shaped recessed-cell regions is adopted, where the area of each recessed-cell region (corresponding to the area of the second region after coating) is 20 μm². Coating the current collector with the negative electrode slurry to obtain a negative electrode active material layer with coated units.

### Embodiments 3 to 8

The preparation method is the same as that in Embodiment 1 except: in Embodiments 3 to 8, the coating thickness of the negative electrode slurry is different, as detailed in Table 1.

### Embodiments 9 to 12

The preparation method is the same as that in Embodiment 1 except: in Embodiments 9 to 12, the area of each non-recessed region (corresponding to the area of the second region after coating) is different, as detailed in Table 1.

### Embodiments 13 to 15

The preparation method is the same as that in Embodiment 1 except: in Embodiments 13 to 15, the particle size of the negative electrode active material is different, as detailed in Table 1.

### Embodiments 16 to 19

The preparation method is the same as that in Embodiment 1 except: in Embodiments 16 to 19, the compacted density of the negative electrode active material is different, as detailed in Table 1.

### Embodiments 20 to 22

The preparation method is the same as that in Embodiment 1 except: in Embodiments 20 to 22, the gram capacity of the negative electrode active material is different, as detailed in Table 1.

### Embodiments 23 to 26

The preparation method is the same as that in Embodiment 2 except: in Embodiments 23 to 26, the coating thickness of the negative electrode slurry is different, as detailed in Table 1.

### Embodiments 27 to 30

The preparation method is the same as that in Embodiment 2 except: in Embodiments 27 to 30, the area of each recessed-cell region (corresponding to the area of the second region after coating) is different, as detailed in Table 1.

### Embodiments 31 to 33

The preparation method is the same as that in Embodiment 2 except: in Embodiments 31 to 33, the particle size of the negative electrode active material is different, as detailed in Table 1.

### Embodiments 34 to 37

The preparation method is the same as that in Embodiment 2 except: in Embodiments 34 to 37, the compacted density of the negative electrode active material is different, as detailed in Table 1.

### Embodiments 38 to 40

The preparation method is the same as that in Embodiment 2 except: in Embodiments 38 to 40, the gram capacity of the negative electrode active material is different, as detailed in Table 1.

### Comparative Embodiment 1

The preparation method is the same as that in Embodiment 1 except: in Comparative Embodiment 1, a general coating method is adopted without using the gravure cylinder that includes specifically shaped non-recessed regions or recessed cell regions.

### Comparative Embodiment 2

The preparation method is the same as that in Comparative Embodiment 1 except: in Comparative Embodiment 2, the gram capacity of the negative electrode active material is different, as detailed in Table 1.

Morphology of the negative electrode electrodes in the foregoing embodiments and comparative embodiments is observed. Subsequently, a cycle performance test, a cycle thickness expansion rate test, a lithium plating test, a deformation rate test, and a test on the circularity after cycles are performed on the lithium-ion batteries, and test results are recorded.

Statistical values of the negative electrode electrodes in Embodiments 1 to 40 and Comparative Embodiments 1 to 2 are shown in Table 1 below. In Embodiment 7, the thickness of the first negative electrode active material layer is 37 μm, and the thickness of the second negative electrode active material layer is 3 μm; in Embodiment 8, the thickness of the first negative electrode active material layer is 42 μm, and the thickness of the second negative electrode active material layer is 8 μm.

TABLE 1

| | Gram | | | | | |
|---|---|---|---|---|---|---|
| | capacity of | | | | | |
| | negative | Gravure cylinder that | | | | |
| | electrode | includes specifically | Compacted density | | Particle size of | |
| Embodiment/ | active | shaped non-recessed | of negative electrode | Thickness of negative | negative electrode | Area of the |
| Comparative | material | regions or recessed | active material layer | electrode active | active material | second region |
| Embodiment | (mAh/g) | cell regions | (g/cm³) | material layer (μm) | (μm) | (μm²) |
| Embodiment 1 | 620.00 | Non-recessed region | 1.3 | 10 | 10 | 20 |
| Embodiment 2 | 620.00 | Recessed cell region | 1.3 | 10 | 10 | 20 |
| Embodiment 3 | 620.00 | Non-recessed region | 1.3 | 8 | 10 | 20 |
| Embodiment 4 | 620.00 | Non-recessed region | 1.3 | 15 | 10 | 20 |
| Embodiment 5 | 620.00 | Non-recessed region | 1.3 | 20 | 10 | 20 |
| Embodiment 6 | 620.00 | Non-recessed region | 1.3 | 30 | 10 | 20 |
| Embodiment 7 | 620.00 | Non-recessed region | 1.3 | 40 | 10 | 20 |
| Embodiment 8 | 620.00 | Non-recessed region | 1.3 | 50 | 10 | 20 |
| Embodiment 9 | 620.00 | Non-recessed region | 1.3 | 10 | 10 | 1 |
| Embodiment 10 | 620.00 | Non-recessed region | 1.3 | 10 | 10 | 2.6 |
| Embodiment 11 | 620.00 | Non-recessed region | 1.3 | 10 | 10 | 52 |
| Embodiment 12 | 620.00 | Non-recessed region | 1.3 | 10 | 10 | 100 |
| Embodiment 13 | 620.00 | Non-recessed region | 1.3 | 10 | 5 | 20 |
| Embodiment 14 | 620.00 | Non-recessed region | 1.3 | 10 | 15 | 20 |
| Embodiment 15 | 620.00 | Non-recessed region | 1.3 | 10 | 20 | 20 |
| Embodiment 16 | 620.00 | Non-recessed region | 0.9 | 10 | 10 | 20 |
| Embodiment 17 | 620.00 | Non-recessed region | 1.03 | 10 | 10 | 20 |
| Embodiment 18 | 620.00 | Non-recessed region | 1.86 | 10 | 10 | 20 |
| Embodiment 19 | 620.00 | Non-recessed region | 1.9 | 10 | 10 | 20 |
| Embodiment 20 | 880.00 | Non-recessed region | 1.3 | 10 | 10 | 20 |
| Embodiment 21 | 1150.00 | Non-recessed region | 1.3 | 10 | 10 | 20 |
| Embodiment 22 | 1420.00 | Non-recessed region | 1.3 | 10 | 10 | 20 |
| Embodiment 23 | 620.00 | Recessed cell region | 1.3 | 3 | 10 | 20 |
| Embodiment 24 | 620.00 | Recessed cell region | 1.3 | 5 | 10 | 20 |
| Embodiment 25 | 620.00 | Recessed cell region | 1.3 | 20 | 10 | 20 |
| Embodiment 26 | 620.00 | Recessed cell region | 1.3 | 50 | 10 | 20 |
| Embodiment 27 | 620.00 | Recessed cell region | 1.3 | 10 | 10 | 1 |
| Embodiment 28 | 620.00 | Recessed cell region | 1.3 | 10 | 10 | 2.6 |
| Embodiment 29 | 620.00 | Recessed cell region | 1.3 | 10 | 10 | 52 |
| Embodiment 30 | 620.00 | Recessed cell region | 1.3 | 10 | 10 | 100 |
| Embodiment 31 | 620.00 | Recessed cell region | 1.3 | 10 | 5 | 20 |
| Embodiment 32 | 620.00 | Recessed cell region | 1.3 | 10 | 15 | 20 |
| Embodiment 33 | 620.00 | Recessed cell region | 1.3 | 10 | 20 | 20 |
| Embodiment 34 | 620.00 | Recessed cell region | 0.9 | 10 | 10 | 20 |
| Embodiment 35 | 620.00 | Recessed cell region | 1.03 | 10 | 10 | 20 |
| Embodiment 36 | 620.00 | Recessed cell region | 1.86 | 10 | 10 | 20 |
| Embodiment 37 | 620.00 | Recessed cell region | 1.9 | 10 | 10 | 20 |
| Embodiment 38 | 880.00 | Recessed cell region | 1.3 | 10 | 10 | 20 |
| Embodiment 39 | 1150.00 | Recessed cell region | 1.3 | 10 | 10 | 20 |
| Embodiment 40 | 1420.00 | Recessed cell region | 1.3 | 10 | 10 | 20 |
| Comparative | 620.00 | Non-gravure coating | 1.3 | 10 | 10 | / |
| Embodiment 1 | | | | | | |
| Comparative | 1420 | Non-gravure coating | 1.3 | 10 | 10 | / |
| Embodiment 2 | | | | | | |

Table 2 shows results of morphology observation of the negative electrodes, and results of the cycle performance test, the cycle thickness expansion rate test, the lithium plating test, the deformation rate test, and the test on the circularity after cycles in Embodiments 1 to 40 and Comparative Embodiments 1 to 2.

TABLE 2

| Embodiment/ | Morphology of first | Circularity of | | | | | |
|---|---|---|---|---|---|---|---|
| Comparative | negative electrode | second region | Lithium plating | Cycle capacity | Cycle thickness | Deformation | Watermark |
| Embodiment | active material layer | after cycles | status | retention rate | expansion rate | rate of | length (mm) |
| Embodiment 1 | Through-hole | 0.52 | No lithium plating | 85.30% | 8.23% | 2.60% | 2.9 |
| Embodiment 2 | Coated unit array + | 0.56 | No lithium plating | 82.45% | 7.68% | 3.12% | 2.5 |
| | seepage region | | | | | | |
| Embodiment 3 | Through-hole | 0.57 | No lithium plating | 85.45% | 6.68% | 3.02% | 2.8 |
| Embodiment 4 | Through-holes + | 0.55 | No lithium plating | 84.45% | 6.78% | 2.82% | 2.6 |
| | semi-closed holes | | | | | | |
| Embodiment 5 | Through-holes + | 0.61 | No lithium plating | 84.33% | 8.63% | 2.46% | 2.7 |
| | semi-closed holes | | | | | | |
| Embodiment 6 | Semi-closed holes + | 0.67 | No lithium plating | 82.56% | 8.83% | 2.65% | 2.9 |
| | closed holes | | | | | | |
| Embodiment 7 | Closed holes | 0.69 | No lithium plating | 83.56% | 7.83% | 2.65% | 2.8 |
| Embodiment 8 | Closed holes | 0.75 | No lithium plating | 81.23% | 9.23% | 2.86% | 2.5 |
| Embodiment 9 | Through-hole | 0.82 | No lithium plating | 78.30% | 8.43% | 3.17% | 2.6 |
| Embodiment 10 | Through-hole | 0.67 | No lithium plating | 84.23% | 8.63% | 2.97% | 2.6 |
| Embodiment 11 | Through-hole | 0.65 | No lithium plating | 85.23% | 7.03% | 2.28% | 2.5 |
| Embodiment 12 | Through-hole | 0.72 | Lithium plating | 45.34% | 6.43% | 2.29% | 2.4 |
| Embodiment 13 | Through-hole | 0.62 | No lithium plating | 87.54% | 8.02% | 2.10% | 2.3 |
| Embodiment 14 | Through-hole | 0.45 | No lithium plating | 82.35% | 9.12% | 2.96% | 2.5 |
| Embodiment 15 | Through-hole | 0.36 | No lithium plating | 78.45% | 8.98% | 3.46% | 2.7 |
| Embodiment 16 | Through-hole | 0.53 | Lithium plating | 0.00% | 4.65% | 1.54% | 3 |
| Embodiment 17 | Through-hole | 0.55 | No lithium plating | 87.15% | 5.56% | 1.67% | 2.9 |
| Embodiment 18 | Through-hole | 0.55 | No lithium plating | 77.15% | 8.56% | 4.67% | 2.9 |
| Embodiment 19 | Through-hole | 0.5 | No lithium plating | 54.60% | 19.45% | 10.76% | 2.9 |
| Embodiment 20 | Through-hole | 0.67 | No lithium plating | 80.54% | 10.02% | 3.87% | 3.2 |
| Embodiment 21 | Through-hole | 0.65 | No lithium plating | 75.45% | 12.45% | 4.56% | 3.5 |
| Embodiment 22 | Through-hole | 0.68 | No lithium plating | 70.23% | 14.67% | 6.45% | 3.7 |
| Embodiment 23 | Coated unit array | 0.72 | No lithium plating | 81.42% | 8.75% | 3.04% | 2.8 |
| Embodiment 24 | Coated unit array + | 0.65 | No lithium plating | 81.12% | 8.65% | 3.24% | 2.6 |
| | seepage region | | | | | | |
| Embodiment 25 | Coated unit array + | 0.62 | No lithium plating | 80.12% | 8.65% | 3.24% | 2.4 |
| | seepage region | | | | | | |
| Embodiment 26 | Seepage region | 0.63 | No lithium plating | 78.67% | 9.74% | 3.56% | 2.7 |
| Embodiment 27 | Coated unit array + | 0.49 | No lithium plating | 74.23% | 9.63% | 3.65% | 2.7 |
| | seepage region | | | | | | |
| Embodiment 28 | Coated unit array + | 0.67 | No lithium plating | 84.23% | 8.63% | 2.65% | 2.7 |
| | seepage region | | | | | | |
| Embodiment 29 | Coated unit array + | 0.65 | No lithium plating | 82.23% | 7.03% | 2.86% | 2.5 |
| | seepage region | | | | | | |
| Embodiment 30 | Coated unit array + | 0.76 | Lithium plating | 65.34% | 6.43% | 2.57% | 2.9 |
| | seepage region | | | | | | |
| Embodiment 31 | Coated unit array + | 0.62 | No lithium plating | 87.54% | 7.68% | 2.61% | 2.9 |
| | seepage region | | | | | | |
| Embodiment 32 | Coated unit array + | 0.45 | No lithium plating | 84.35% | 8.63% | 2.57% | 2.5 |
| | seepage region | | | | | | |
| Embodiment 33 | Coated unit array + | 0.37 | No lithium plating | 78.35% | 8.93% | 2.53% | 2.3 |
| | seepage region | | | | | | |
| Embodiment 34 | Coated unit array + | 0.56 | Lithium plating | 0.00% | 5.65% | 1.74% | 2.7 |
| | seepage region | | | | | | |
| Embodiment 35 | Coated unit array + | 0.61 | No lithium plating | 84.15% | 6.56% | 1.87% | 2.5 |
| | seepage region | | | | | | |
| Embodiment 36 | Coated unit array + | 0.67 | No lithium plating | 75.60% | 10.45% | 5.76% | 2.5 |
| | seepage region | | | | | | |
| Embodiment 37 | Coated unit array + | 0.67 | No lithium plating | 55.60% | 17.45% | 10.76% | 2.5 |
| | seepage region | | | | | | |
| Embodiment 38 | Coated unit array + | 0.67 | No lithium plating | 80.54% | 10.02% | 3.87% | 3.1 |
| | seepage region | | | | | | |
| Embodiment 39 | Coated unit array + | 0.65 | No lithium plating | 77.55% | 11.45% | 4.76% | 3.4 |
| | seepage region | | | | | | |
| Embodiment 40 | Coated unit array + | 0.68 | No lithium plating | 68.33% | 16.67% | 7.15% | 4 |
| | seepage region | | | | | | |
| Comparative | / | / | No lithium plating | 62.33% | 17.67% | 8.15% | 7 |
| Embodiment 1 | | | | | | | |
| Comparative | / | / | No lithium plating | 48.33% | 18.67% | 11.15% | 12 |
| Embodiment 2 | | | | | | | |

As shown in Tables 1 and 2, in the embodiments and comparative embodiments, for the negative electrodes with the same gram capacity, with the increase of the percentage of the area of coated through-holes (that is, the area of the second region), the cycle stability increases gradually, the thickness growth of the battery cell and the deformation of the battery cell are effectively alleviated after cycles. However, when the percentage of the area of the through-holes or the coated units (that is, the area of the second region) is excessive, the lithium plating is prone to occur during cycles, resulting in plunging of the cycle capacity. When the area of a single through-hole or coated unit (that is, the area of the second region) is insufficient, the through-holes are prone to close or the coated units are prone to collapse, and finally, the effect of increasing the cycle capacity retention rate is not significant. When the area of a single through-hole or coated unit (that is, the area of the second region) is excessive, lithium plating is prone to occur at the through-holes and the seepage region.

The shape of the through-holes or coated unit arrays exerts an effect on the retention of the cycle capacity and the suppression of battery cell expansion and deformation. The higher the symmetry of the through-holes or coated unit arrays, the better the effect. The gram capacity of the negative electrode active material exerts a significant effect on alleviating the cycle expansion and deformation of the negative electrode. As the gram capacity of the negative electrode active material increases, the cycle expansion of the negative electrode increases, the deformation intensifies, and in turn, the cycle capacity retention rate decreases on condition that the percentage of the area of the through-holes or coated unit array (that is, the area of the second region) remains constant. Meanwhile, it is found that the coating method adopting a gravure cylinder that includes specifically shaped non-recessed regions or recessed cell regions according to this application can reduce coating watermarks effectively. As can be seen from the results of the embodiments and comparative embodiments, depending on the gram capacity of the negative electrode active material, when the percentage of the area of the through-holes or the coated unit array (that is, the area of the second region) falls within the range specified by the embodiments of this application, the cycle expansion rate and the deformation rate of lithium-ion batteries are effectively reduced, and a high cycle capacity retention rate is maintained.

By comparing the embodiments and comparative embodiments, it can be clearly understood that, by designing the negative electrode active material layer of the negative electrode into a specified coating structure, the electrochemical device according to this application can reduce the cycle thickness expansion rate and the deformation rate while maintaining a high energy density of the negative electrode active material. In addition, by controlling the relationship between the compacted density of the negative electrode active material layer and the gram capacity of the negative electrode active material or by controlling the relationship between the area of the second region, the gram capacity of the negative electrode active material, and the particle size of the negative electrode active material, this application can further optimize the cycle expansion status of the cycle capacity retention rate of the electrochemical device, thereby improving the cycle performance and safety performance of the electrochemical device.

References to “embodiments”, “some embodiments”, “an embodiment”, “another example”, “example”, “specific example” or “some examples” throughout the specification mean that at least one embodiment or example in this application includes specific features, structures, materials, or characteristics described in the embodiment(s) or example(s). Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment or example in this application. In addition, specific features, structures, materials, or characteristics herein may be combined in one or more embodiments or examples in any appropriate manner.

Although illustrative embodiments have been demonstrated and described above, a person skilled in the art understands that the above embodiments are not to be construed as a limitation on this application, and changes, replacements, and modifications may be made to the embodiments without departing from the spirit, principles, and scope of this application.

What is claimed is:

1. An electrochemical device, comprising:
a positive electrode;
a separator; and
a negative electrode, wherein the negative electrode comprises a negative electrode current collector and a negative electrode active material layer, the negative electrode active material layer comprises a negative electrode active material, and the negative electrode active material layer comprises a first negative electrode active material layer;
wherein, when the electrochemical device is at 0% SOC, the first negative electrode active material layer comprises a first region and at least one second region, the first region is continuous as a whole, and at least a part of the second region is surrounded by the first region.

2. The electrochemical device according to claim 1, wherein the negative electrode active material layer further comprises a binder.

3. The electrochemical device according to claim 2, wherein the first region is coated with the negative electrode active material and the binder, and the second region is not coated with the negative electrode active material or the binder.

4. The electrochemical device according to claim 2, wherein the first region is not coated with the negative electrode active material or the binder, and the second region is coated with the negative electrode active material and the binder.

5. The electrochemical device according to claim 1, wherein the negative electrode active material layer further comprises a second negative electrode active material layer, the second negative electrode active material layer is disposed between the negative electrode current collector and the first negative electrode active material layer, or the first negative electrode active material layer is disposed between the negative electrode current collector and the second negative electrode active material layer,
and a thickness of the first negative electrode active material layer is greater than or equal to 3 times a thickness of the second negative electrode active material layer.

6. The electrochemical device according to claim 1, wherein the at least one second region includes a plurality of second regions and the plurality of second regions are distributed in form of an array.

7. The electrochemical device according to claim 1, wherein a circularity of the second region falls within a range of 0.3 to 1.0.

8. The electrochemical device according to claim 1, wherein a compacted density M g/cm³ of the negative electrode active material layer and a gram capacity G mAh/g of the negative electrode active material satisfy the following formula:
2500/(G+1800)≤M≤4500/(G+1800).

9. The electrochemical device according to claim 1, wherein an area A μm² of the second region, a gram capacity G mAh/g of the negative electrode active material, and a particle size D μm of the negative electrode active material satisfy the following formula:
$$\frac{{{D}^{2} ( G - 360 )}^{2}}{1 {0}^{9}} \leq A \leq \frac{{{D}^{2} ( G - 360 )}^{2}}{1 {0}^{6}} .$$

10. An electronic device, comprising an electrochemical device, wherein the electrochemical device comprises:
a positive electrode;
a separator; and
a negative electrode, wherein the negative electrode comprises a negative electrode current collector and a negative electrode active material layer, the negative electrode active material layer comprises a negative electrode active material, and the negative electrode active material layer comprises a first negative electrode active material layer;
wherein, when the electrochemical device is at 0% SOC, the first negative electrode active material layer comprises a first region and at least one second region, the first region is continuous as a whole, and at least a part of the second region is surrounded by the first region.

11. The electronic device according to claim 10, wherein the negative electrode active material layer further comprises a binder.

12. The electronic device according to claim 11, wherein the first region is coated with the negative electrode active material and the binder, and the second region is not coated with the negative electrode active material or the binder.

13. The electronic device according to claim 11, wherein the first region is not coated with the negative electrode active material or the binder, and the second region is coated with the negative electrode active material and the binder.

14. The electronic device according to claim 10, wherein the negative electrode active material layer further comprises a second negative electrode active material layer, the second negative electrode active material layer is disposed between the negative electrode current collector and the first negative electrode active material layer, or the first negative electrode active material layer is disposed between the negative electrode current collector and the second negative electrode active material layer, and
a thickness of the first negative electrode active material layer is greater than or equal to 3 times a thickness of the second negative electrode active material layer.

15. The electronic device according to claim 10, wherein the at least one second region includes a plurality of second regions and the plurality of second regions are distributed in form of an array.

16. The electronic device according to claim 10, wherein a circularity of the second region falls within a range of 0.3 to 1.0.

17. The electronic device according to claim 10, wherein a compacted density M g/cm³ of the negative electrode active material layer and a gram capacity G mAh/g of the negative electrode active material satisfy the following formula:
2500/(G+1800)≤M≤4500/(G+1800).

18. The electronic device according to claim 10, wherein an area A μm² of the second region, a gram capacity G mAh/g of the negative electrode active material, and a particle size D μm of the negative electrode active material satisfy the following formula:
$$\frac{{{D}^{2} ( G - 360 )}^{2}}{1 {0}^{9}} \leq A \leq \frac{{{D}^{2} ( G - 360 )}^{2}}{1 {0}^{6}} .$$

19. A method for preparing an electrochemical device, the method comprising:
preparing a mixed slurry; and
coating a negative electrode current collector with the mixed slurry by using a gravure cylinder to form a negative electrode active material layer;
wherein, when the electrochemical device is at 0% SOC, the first negative electrode active material layer comprises a first region and at least one second region, the first region is continuous as a whole, and at least a part of the second region is surrounded by the first region.

20. The method according to claim 19, wherein the gravure cylinder comprises a plurality of recessed cell regions or a plurality of non-recessed regions.
